(19) United States
(12) Patent Application Publication
(10) Pub. No.: US 2024/0191734 A1
(43) Pub. Date: Jun. 13, 2024

(54) HOLED ELEMENT AND LOCKING ELEMENT ASSEMBLY

(71) Applicant: Wistron NeWeb Corporation, Hsinchu (TW)

(72) Inventor: Yu-Kai CHIU, Hsinchu (TW)

(21) Appl. No.: 18/536,439

(22) Filed: Dec. 12, 2023

(30) Foreign Application Priority Data
Dec. 13, 2022 (TW) 111147764

(51) Int. Cl. F16B 2/22

(52) U.S. Cl. CPC F16B 2/22

(57) ABSTRACT

A holed element is plate-shaped and includes a first curved surface, a second curved surface, two interface surfaces, a main hole, two slots, and two elastic sections. A length of the second curved surface is less than a length of the first curved surface. Each of the two interface surfaces is concave relative to the first curved surface and the second curved surface. The main hole is formed and surrounded by the first curved surface, the second curved surface, and the two interface surfaces. The main hole includes a first hole portion and a second hole portion which respectively correspond to the first curved surface and the second curved surface. The two slots are respectively disposed at two opposite sides of the main hole. Each of the elastic sections is formed between a corresponding one of the two slots and the main hole.

### RELATED APPLICATIONS

This application claims the benefit of priority to Taiwan Patent Application No. 111147764, filed on Dec. 13, 2022. The entire content of the above identified application is incorporated herein by reference.

### BACKGROUND

### Technical Field

The present disclosure relates to a holed element and a locking element assembly, and more particularly, to a holed element and a locking element with a gourd-shaped hole.

### Description of Related Art

Household or industrial products such as hanging brackets and connecting parts often use holed-components, and the holed-components may be combined with protruding components to form a snap-fit assembly, which is used for hanging objects, changing hanged objects, or connecting two objects. However, to ensure the snap-fit assembly remains securely locked, it is common to make the insertion or removal of the protruding components from the holed-components so tight that user experience is affected and components are prone to be broken due to repeated use or aging.

In view of this, there is an urgent need in the current market for holed-components and their corresponding protruding components in snap-fit assemblies that can improve the user experience during insertion and removal and have extended service life.

### SUMMARY

In one aspect, the present disclosure provides a holed element that is plate-shaped and includes a first curved surface, a second curved surface, two interface surfaces, a main hole, two slots, and two elastic sections. A length of the second curved surface is less than a length of the first curved surface. One of the two interface surfaces is connected to one end of the first curved surface and one end of the second curved surface. The other one of the two interface surfaces is connected to the other end of the first curved surface and the other end of the second curved surface. Each of the two interface surfaces is concave relative to the first curved surface and the second curved surface. The main hole is formed and surrounded by the first curved surface, the second curved surface, and the two interface surfaces. The main hole includes a first hole portion and a second hole portion which respectively correspond to the first curved surface and the second curved surface. The two slots are respectively disposed at two opposite sides of the main hole. Each of the two elastic sections is formed between a corresponding one of the two slots and the main hole.

In another aspect, the present disclosure provides a locking element assembly that includes the aforementioned holed element and a protruding element. The protruding element includes a head portion and a body portion connected to the head portion. When the holed element and the protruding element are in a locked state, the two interface surfaces of the holed element limit the body portion in the second hole portion along the center axis, and the head portion limits the body portion in the second hole portion along a normal direction of a flat surface of the holed element.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of a holed element according to a first embodiment of the present disclosure.

FIG. 1B is a top view of the holed element shown in FIG. 1A.

FIG. 1C is another top view of the holed element shown in FIG. 1A.

FIG. 2A is a three-dimensional view of a locking element assembly according to a second embodiment of the present disclosure.

FIG. 2B is an exploded view of the locking element assembly shown in FIG. 2A.

FIG. 2C is a side view of the locking element assembly shown in FIG. 2A.

FIG. 2D is a cross-sectional view of the locking element assembly taken along line 2D-2D of FIG. 2C.

FIG. 2E is a schematic view of the locking element assembly shown in FIG. 2D transitioning from an unlocked state to a locked state.

FIG. 2F is a schematic view of the locking element assembly shown in FIG. 2D transitioning from the locked state to the unlocked state.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

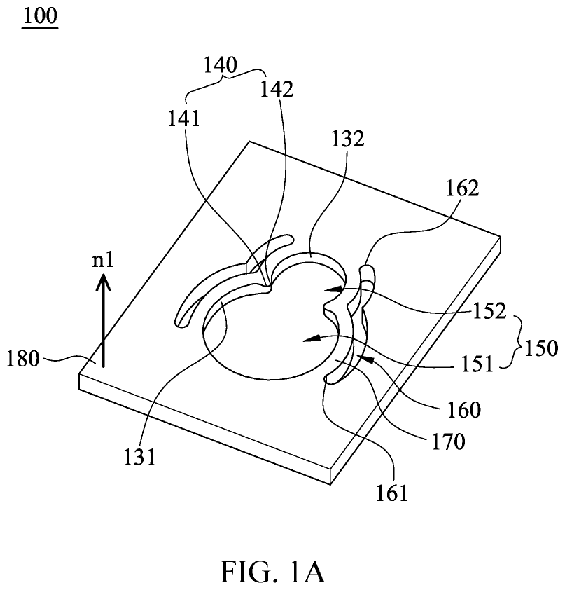

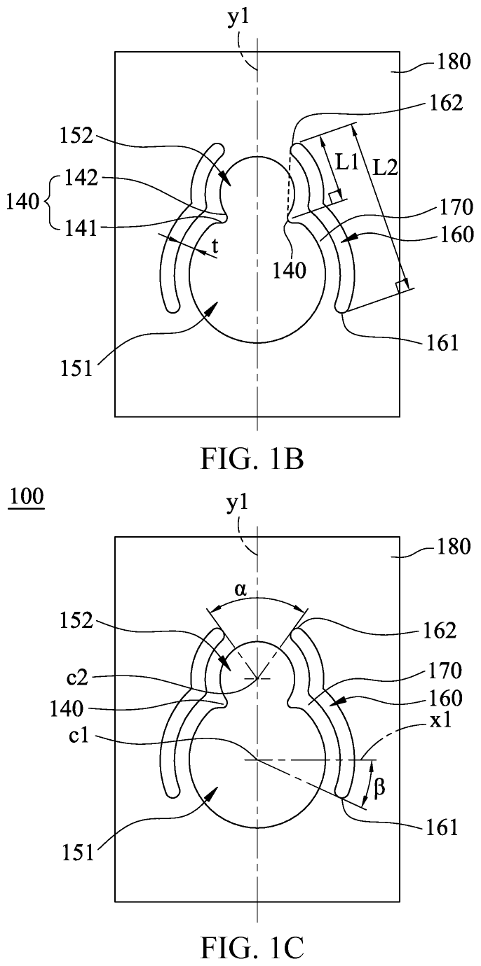

FIG. 1A is a three-dimensional view of a holed element 100 according to a first embodiment of the present disclosure, and FIG. 1B and FIG. 1C are respective top views of the holed element 100 shown in FIG. 1A. Referring to FIG. 1A to FIG. 1C, the holed element 100 is plate-shaped and includes a first curved surface 131, a second curved surface 132, two interface surfaces 140, a main hole 150, two slots 160, and two elastic sections 170.

The first curved surface 131 and the second curved surface 132 are strip-shaped and, as shown in FIG. 1B and FIG. 1C, are arc-shaped, and thus the first curved surface 131 and the second curved surface 132 are arc-strip-shaped. The length of the second curved surface 132 is less than the length of the first curved surface 131 as shown in FIG. 1A to FIG. 1C. One interface surface 140 is connected to/between one end of the first curved surface 131 and one end of the second curved surface 132, and the other interface surface 140 is connected to/between the other end of the first curved surface 131 and the other end of the second curved surface 132. Each interface surface 140 is concave relative to the first curved surface 131 and the second curved surface 132, and so the main hole 150 has a narrower opening at the location corresponding to the interface surfaces 140 comparing to adjacent locations. The main hole 150 is formed and surrounded by the first curved surface 131, the second curved surface 132, and the two interface surfaces 140, and includes a first hole portion 151 and a second hole portion 152. The first hole portion 151 and the second hole portion 152 respectively correspond to the first curved surface 131 and the second curved surface 132. The two slots 160 are respectively disposed at two opposite sides of the main hole 150 and perforate through the holed element 100. The two slots 160 are two side holes on the holed element 100, and each elastic section 170 is formed between a corresponding slot 160 and the main hole 150. Hence, through the property of the elastic section 170 being expandable, the holed element 100 provides proper elastic force to the object accommodated in the main hole 150 and in contact with the interface surfaces 140, like a protruding element 200 in the second embodiment. It is to be noted that the periphery of the holed element of the present disclosure is not limited to the rectangular shape shown in FIG. 1A to FIG. 1C.

In specific, the main hole 150 may be substantially gourd-shaped, in other words, the main hole 150 is a gourd-hole or a key-hole. The main hole 150 may be symmetrical along the center axis y1, and the two slots 160 may be symmetrically disposed along the center axis y1. Thus, the holed element 100 is able to provide a balanced elastic force along the center axis y1.

One end of each slot 160 is a first slot end 161 and may be adjacent to the first curved surface 131, and the other end of each slot 160 is a second slot end 162 and may be adjacent to the second curved surface 132. Therefore, the two elastic sections 170 are two spring arms respectively at two sides of the main hole 150, which prevent an over-pulling with excessive force and in turn reduce the risk of the elastic sections 170 cracking due to overuse or aging.

Referring to FIG. 1B, for each slot 160, a first reference length L2 is the length of an end-connecting line between the first slot end 161 and the second slot end 162. The connecting line between the interface surface 140 and the second slot end 162 is shown by the dotted line in FIG. 1B, and a second reference length L1 is the length of the connecting line (the dotted line) along a direction parallel to the end-connecting line. The ratio of the first reference length L2 to the second reference length L1 is greater than or equal to 2.5 and less than or equal to 4.0, in other words, the relation between the two reference lengths L2, L1 is 2.5≤L2/L1≤4.0. Thus, the proper structural ratio of the slot 160 is advantageous in prolonging the service life of the holed element 100. In the first embodiment, the first reference length L2 is 14.86 mm, and the second reference length L1 is 5.88 mm, so the L2/L1 is 2.53.

For each slot 160, the distance t between the slot 160 and the first curved surface 131, which is the width of the part of each elastic section 170 that corresponds to the first curved surface 131, can be equal to the distance between the slot 160 and the second curved surface 132 (the width of the part of each elastic section 170 that corresponds to the second curved surface 132). As such, the elastic forces designed corresponding to the first hole portion 151 and the second hole portion 152 of the elastic sections 170 can be similar. In other words, through each elastic section 170, an elastic arm structure is formed between the slot 160 and the main hole 150 to provide elastic arm property to the elastic section 170, and the elastic arm structure provides proper elastic force to the object accommodated in the main hole 150 and in contact with the interface surfaces 140. The width of the elastic arm structure between the slot 160 and the main hole 150 (the first hole portion 151 and the second hole portion 152) is the distance t.

The relation between the second reference length L1 and the distance t between the slot 160 and the first curved surface 131 is 3.0≤L1/t≤5.0. As such, the proper elastic force and hole size between the two interface surfaces 140 can be designed through the length-width ratio of the parts of the elastic sections 170 that correspond to the second hole portion 152. In the first embodiment, the second reference length L1 is 5.88 mm, and the distance t is 1.25 mm, so L1/t is 4.70.

The relation between the first reference length L2 and the distance t between the slot 160 and the first curved surface 131 is 10.5≤L2/t≤21.5. Through the length-width ratio of the elastic section 170, the proper elastic force can be designed. In the first embodiment, the first reference length L2 is 14.86 mm, and the distance t is 1.25 mm, so L2/t is 11.89.

Referring to FIG. 1C as the top view, the first curved surface 131 is arc-shaped, and so the first curved surface 131 can be arc-strip-shaped and have a first center of circle c1. The second curved surface 132 is arc-shaped shown in FIG. 1C as the top view, and so the second curved surface 132 can be arc-strip-shaped and have a second center of circle c2. Thus, the holed element 100 provides evenly distributed elastic forces and, in addition, is easy to be assembled with a circular protruding element or protruding element of other shape to form a locking element assembly.

The included angle α between a line connecting one of the second slot ends 162 and the second center of circle c2 and a line connecting the other one of the second slot ends 162 and the second center of circle c2 is greater than or equal to 45 degrees and less than or equal to 130 degrees. As such, the length of slot 160 is not too long or too short, and so a proper elastic force and the structural stability of the holed element 100 can be maintained. In the first embodiment, the included angle α is 71.58 degrees.

A horizontal line x1 is perpendicular to the center axis y1 and passes through the first center of circle c1, and the included angle β between the line connecting one of the first slot ends 161 and the first center of circle c1 and the horizontal line x1 is greater than or equal to 0 degrees and less than or equal to 40 degrees. As such, the length of the slot 160 is prevented from being too long or too short, which helps in maintaining the proper elastic force and the structural stability. In the first embodiment, the included angle ß is 24.65 degrees.

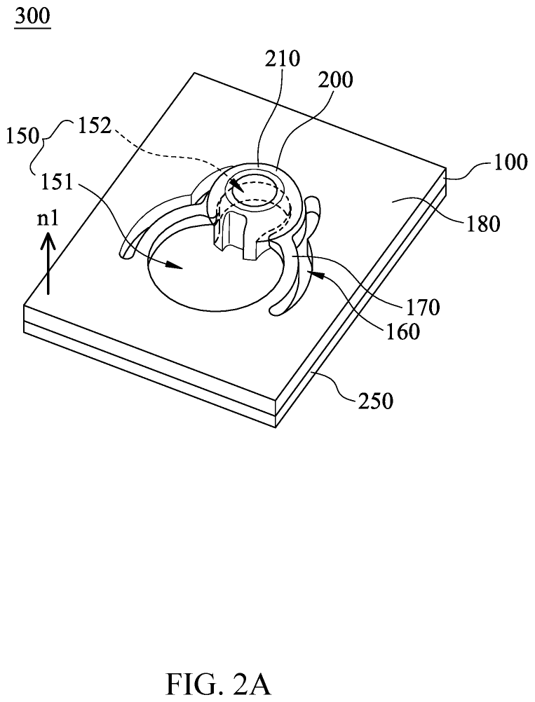

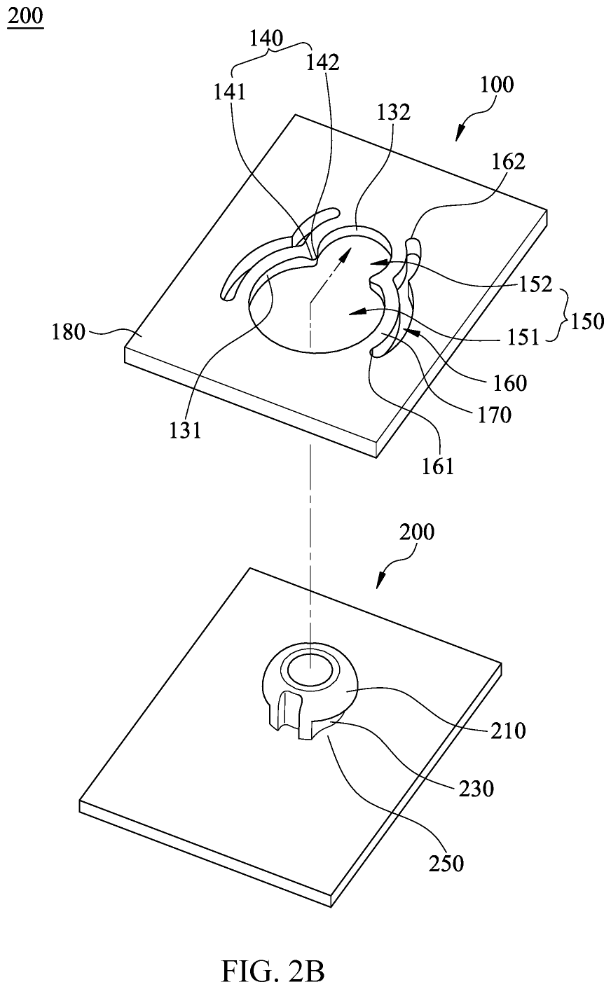

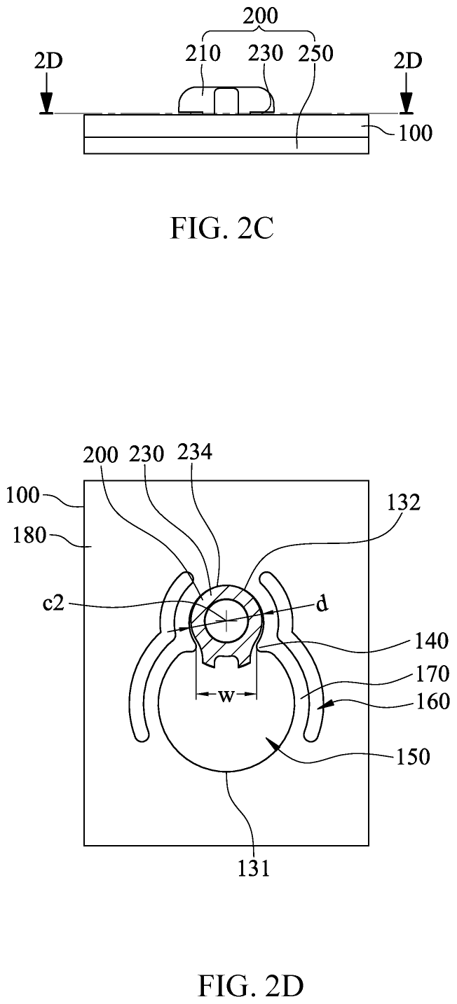

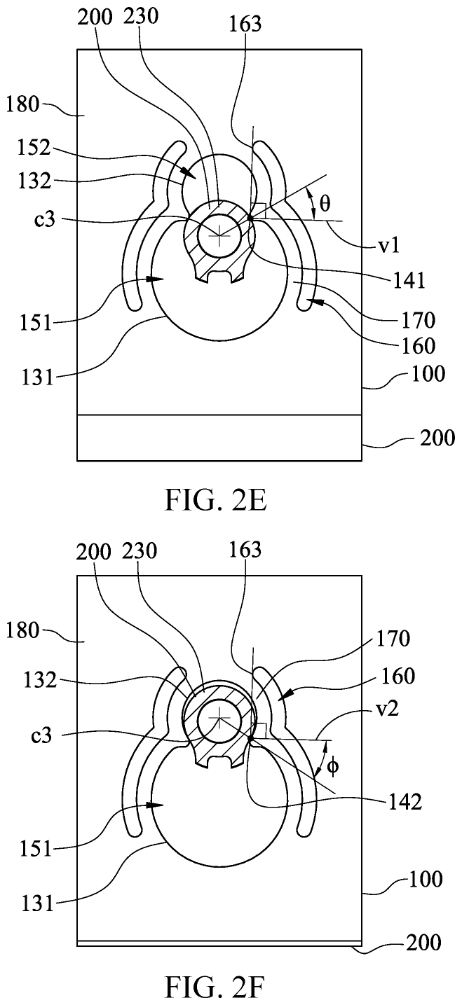

FIG. 2A is a three-dimensional view of a locking element assembly 300 according to a second embodiment of the present disclosure in a locked state, FIG. 2B is an exploded view of the locking element assembly 300 shown in FIG. 2A in an unlocked state, and FIG. 2C is a side view of the locking element assembly 300 shown in FIG. 2A. Referring to FIG. 2A to FIG. 2C, the locking element assembly 300 includes the holed element 100 of the first embodiment and a protruding element 200.

The protruding element 200 includes a head portion 210 and a body portion 230, and the body portion 230 is connected to the head portion 210. When the holed element 100 and the protruding element 200 are in a locked state as shown in FIG. 2A and FIG. 20, the interface surfaces 140 of the holed element 100 limit the body portion 230 in the second hole portion 152 along the direction of the center axis y1. At this time, the second curved surface 132 of the holed element 100 surrounds the body portion 230 of the protruding element 200, and the head portion 210 limits the body portion 230 in the second hole portion 152 along the normal direction n1 of a flat surface 180 of the holed element 100. Thus, when the protruding element 200 is inserted into or pulled out from the holed element 100, a force feedback of insertion or pulling-out (removal) is generated by the expansion of the elastic sections 170. Moreover, the locking element assembly 300 according to the present disclosure can be used in products like hanging brackets, connecting components, etc., and the product can include a set or multiple sets of locking element assemblies 300. In addition, the periphery of the protruding element in the locking element assembly is not limited to be rectangular shape as shown in FIG. 2A, and is not limited to be overlapping with the periphery of the holed element in the locking element assembly.

In specific, the protruding element 200 may further include a block portion 250, and the body portion 230 is connected between the head portion 210 and the block portion 250. When the holed element 100 and the protruding element 200 are in a locked state, the block portion 250 limits the body portion 230 in the second hole portion 152 along the normal direction n1 of the flat surface 180 of the holed element 100.

FIG. 2D is a cross-sectional view of the locking element assembly 300 taken along line 2D-2D of FIG. 2C. Referring to FIG. 2C and FIG. 2D, the projected periphery 234 of the body portion 230 projected on the flat surface 180 of the holed element 100 may be substantially a circle or include a major arc (arc measure with more than 180 degrees). The part of the body portion 230 that corresponds and in contact with the second curved surface 132 of the holed element 100 is arc-strip-shaped, and the head portion 210 and the body portion 230 as a whole has a mushroom-like structure. A locking opening is represented by a distance w between the two interface surfaces 140 of the holed element 100, and a relation between the distance w and the diameter d of the projected periphery 234 on the flat surface 180 of the holed element 100 is 78%≤w/d≤92%. Hence, the force feedback during the protruding element 200 being inserted into or pulled out from the locking element assembly 300 is enhanced. In the second embodiment, the distance w is 5.1 mm, and the diameter d is 6 mm, so w/d is 85%.

FIG. 2E and FIG. 2F are schematic views of the locking element assembly 300 shown in FIG. 2D transitioning from the unlocked state to the locked state and from the locked state to the unlocked state, respectively. Referring to FIG. 2B, FIG. 2E, and FIG. 2F, when the holed element 100 and the protruding element 200 are in the unlocked state, the head portion 210 of the protruding element 200 is able to pass through the first hole portion 151. During the transitions, either from the unlocked state to the locked state or from the locked state to the unlocked state, the two elastic sections 170 of the holed element 100 may deform. Hence, the design of the slots 160 enhances user experience without having to incur extra production cost.

The holed element 100 can be made of a plastic material to enhance elasticity of the holed element 100 and reduce cost.

Referring to FIG. 2E, the body portion 230 has a body center of circle c3. During the transition of the unlocked state to the locked state, the head portion 210 and the body portion 230 of the protruding element 200 move from the first hole portion 151 toward the second hole portion 152. When the body portion 230 comes in contact with two first contact points 141 of the two interface surfaces 140 of the holed element 100, a first perpendicular line v1 is defined to be a line perpendicular to a line connecting a deformation point 163 of one of the second slot ends 162 and the corresponding first contact point 141, and an included angle θ is between a line connecting the corresponding first contact point 141 and the body center of circle c3 and the first perpendicular line v1. The included angle θ is the angle of force actuation for installation or insertion. Referring to FIG. 2F, during the transition of the locked state to the unlocked state, the head portion 210 and the body portion 230 of the protruding element 200 move from the second hole portion 152 toward the first hole portion 151. When the body portion 230 comes in contact with two second contact points 142 of the two interface surfaces 140 of the holed element 100, a second perpendicular line v2 is defined to be a line perpendicular to a line connecting a deformation point 163 of one of the second slot ends 162 and the corresponding second contact point 142, and an included angle ϕ is between the line connecting the corresponding second contact point 142 and the body center of circle c3 and the second perpendicular line v2. The included angle $ is the angle of force actuation for uninstallation or removal. The locking element assembly 300 may meet the following condition: 0 degrees≤|θ-ϕ|≤15 degrees, thereby ensuring the elastic forces for inserting the protruding element 200 into or removing the protruding element 200 from the holed element 100 are similar to prevent having to put in more effort for one action than the other. Thus, the force feedback, user experience, and quality of the locking element assembly 300 are enhanced. In the second embodiment, the included angle θ is 31.62 degrees, and the included angle ϕ is 27.06 degrees, so the |θ-ϕ| is 4.56 degrees.

Referring to FIG. 2C, each of the head portion 210 and the body portion 230 can be an open hollow structure or a closed hollow structure. The user experience can further be enhanced through the structural property of the protruding element 200. It is to be noted that the present disclosure does not limit the structures of the head portion and the body portion, and the hollow type and the solid type can have similar designs.

In view of the above, the holed element of the present disclosure is equipped with elastic arm structure, and with specific size and design parameters, thus proper feedback forces are provided. The feedback forces for both the insertion scenario and the removal scenario are similar, which further enhances user experience of the product.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A holed element, comprising:
a first curved surface;
a second curved surface, wherein a length of the second curved surface is less than a length of the first curved surface;
two interface surfaces, wherein one of the two interface surfaces is connected to one end of the first curved surface and one end of the second curved surface, the other one of the two interface surfaces is connected to the other end of the first curved surface and the other end of the second curved surface, and each of the two interface surfaces is concave relative to the first curved surface and the second curved surface;
a main hole, formed and surrounded by the first curved surface, the second curved surface, and the two interface surfaces, and comprising a first hole portion and a second hole portion, wherein the first hole portion and the second hole portion respectively correspond to the first curved surface and the second curved surface;
two slots respectively disposed at two opposite sides of the main hole; and
two elastic sections, wherein each of the two elastic sections is formed between a corresponding one of the two slots and the main hole;
wherein the holed element is plate-shaped.

2. The holed element according to claim 1, wherein the main hole is substantially gourd-shaped.

3. The holed element according to claim 1, wherein the main hole is symmetric along a center axis, and the two slots are symmetrically disposed along the center axis.

4. The holed element according to claim 3, wherein one end of each of the two slots is a first slot end and adjacent to the first curved surface, and the other end of each of the two slots is a second slot end and adjacent to the second curved surface.

5. The holed element according to claim 4, wherein for each of the two slots, a first reference length L2 is a length of an end-connecting line between the first slot end and the second slot end, a second reference length L1 is a length of a connecting line between the interface surface and the second slot end along a direction parallel to the end-connecting line, and 2.5≤L2/L1≤4.0.

6. The holed element according to claim 5, wherein a distance between each of the two slots and the first curved surface is equal to a distance between each of the two slots and the second curved surface.

7. The holed element according to claim 6, wherein the distance between each of the two slots and the first curved surface is t, and 3.0≤L1/t≤5.0.

8. The holed element according to claim 6, wherein the distance between each of the two slots and the first curved surface is t, and 10.5≤L2/t≤21.5.

9. The holed element according to claim 4, wherein the first curved surface is arc-strip-shaped and comprises a first center of circle, and the second curved surface is arc-strip-shaped and comprises a second center of circle.

10. The holed element according to claim 9, wherein an included angle α between a line connecting the second slot end of one of the two second slots and the second center of circle and a line connecting the second slot end of the other one of the two second slots and the second center of circle is between 45 degrees and 130 degrees.

11. The holed element according to claim 9, wherein an included angle ß between a horizontal line perpendicular to the center axis and a line connecting one of the first slot ends and the first center of circle is between 0 degrees and 40 degrees.

12. A locking element assembly, comprising:
the holed element as described in claim 1; and
a protruding element, comprising a head portion and a body portion connected to the head portion;
wherein, when the holed element and the protruding element are in a locked state, the two interface surfaces of the holed element limit the body portion in the second hole portion along a center axis, and the head portion limits the body portion in the second hole portion along a normal direction of a flat surface of the holed element.

13. The locking element assembly according to claim 12, wherein a projected periphery of the body portion on the flat surface of the holed element is substantially circular, and a relation of a distance w between the two interface surfaces and a diameter d of the projected periphery of the body portion on the flat surface of the holed element is 78%≤w/d≤92%.

14. The locking element assembly according to claim 12, wherein when the holed element and the protruding element are in an unlocked state, the head portion of the protruding element is able to pass through the first hole portion, and during a transition between the unlocked state and the locked state, the two elastic sections of the holed element deform.

15. The locking element assembly according to claim 14, wherein the holed element is made of a plastic material.

16. The locking element assembly according to claim 14, wherein the body portion has a body center of circle, and one end of each of the two slots is a second slot end and adjacent to the second curved surface;
wherein, during a transition of the unlocked state to the locked state, the head portion and the body portion of the protruding element move from the first hole portion toward the second hole portion, and when the body portion comes in contact with two first contact points of the two interface surfaces, a first perpendicular line is defined to be a line perpendicular to a line connecting a deformation point of one of the two second slot ends and a corresponding one of the two first contact points, and an included angle between a line connecting the corresponding one of the two first contact points and the body center of circle and the first perpendicular line is θ;
wherein, during a transition of the locked state to the unlocked state, the head portion and the body portion of the protruding element move from the second hole portion toward the first hole portion, and when the body portion comes in contact with two second contact points of the two interface surfaces, a second perpendicular line is defined by a line perpendicular to a line connecting the deformation point of one of the two second slot ends and a corresponding one of the two second contact points, and an included angle between a line connecting the corresponding one of the two second contact points and the body center of circle and the second perpendicular line is wherein 0 degrees≤|θ-ϕ|≤15 degrees.

17. The locking element assembly according to claim 12, wherein the head portion and the body portion are hollow structures.
